(19) United States
(12) Patent Application Publication
(10) Pub. No.: US 2006/0162588 A1
(43) Pub. Date: Jul. 27, 2006

(54) Four-piece modular frame screen printing assembly

(76) Inventor: Ronald Salisbury, San Diego, CA (US)

Correspondence Address: Steven W.. Webb;Law Offices of Steven W. Webb, 655 2nd Street, Encinitas, CA, 92024, US

(21) Appl. No.: 11/041,707

(22) Filed: Jan. 25, 2005

(51) Int. Cl. B05C 17/08

(52) U.S. Cl. 101/127.1

(57) ABSTRACT

An improved screen printing frame is presented that is assembled from four separately cast screen sides. The screen printing frame is designed to be assembled into a rectangular shape from four lengths of injection-molded or die-cast plastic or metal that are assembled into a rectangular shape. A fabric screen is then stretched over the upper surface. In an alternate embodiment, the plastic upper surface of the screen possesses a metal liner to make attaching the screen fabric easier.

BACKGROUND OF THE INVENTION

This invention relates to rectangular or square screen printing frames and in particular to an improvement in screen printing frame design and manufacture to decrease cost and increase modularity.

Existing rectangular and square screen printing frames are made out of wood or extruded aluminum hollow tubing side members with rectangular or square cross-sections. Metal frames are welded or screwed together. Wooden frames must be cut and formed, then connected with fasteners and/or glue. Each frame requires a certain amount of manpower to manufacture from its component parts.

Typical screens are made out of wood or extruded aluminum hollow tubing side members with rectangular or square cross-sections. Each of these component materials has limitations. Welding the aluminum frames together is expensive and requires relatively thicker metal in the side members, thereby increasing the weight of the screen. Wooden frames must be cut and formed, then connected with fasteners and/or glue. Each frame requires a certain amount of manpower to manufacture from its component parts.

A recurring problem with screen printing frames is that they need to be washed with water regularly between uses. The solid wooden frames can warp or crack after repeated washings. While aluminum does not absorb water, a pinhole in a frame weld will allow water into the hollow frame interior.

Plastic frames are light-weight and low-cost, but a plastic hollow-tube frame is not strong enough to hold the tension on the silkscreen itself and still has to be cut and joined. A plastic screen with an open design and integral bracing members solves the weight and strength problem.

None of the prior art screen frame devices have this approach, a single-piece injection-mold or casting of rigid material. The present invention differs from the state-of-the-art devices by virtue of its low-cost manufacture, its modularity, its ease of assembly with the silk screen itself, and its self-drying capability.

### BRIEF SUMMARY OF THE INVENTION

The present invention allows users to assemble a screen of any rectangular dimensions out of component frame parts injection molded or cast from metal or plastic that attach easily to each other. By selecting two components of length A and two components of length B, a screen frame of dimensions A×B can be made. Using the connectors cast or molded into each connector, the frame can be assembled easily with glue to make a solid fit.

The present invention best mode will be molded from metal or plastic. Plastic frames are light-weight and low-cost, but the weight will be minimized while retaining structural strength by using ribbing cast into the frame components. This will provide an integral bracing mechanism while permitting single-piece casting.

None of the prior art screen frame devices have this approach, a modular screen frame design. The present invention differs from the state-of-the-art devices by virtue of its low-cost manufacture and its ease of assembly from pre-cast modular parts.

It is an object of this invention to provide a screen printing frame that is low-cost to manufacture.

It is an object of this invention to provide a screen printing frame that is made from cast or injection molded metal or plastic material.

It is an object of this invention to provide a screen printing frame that is light-weight, strong and durable in use.

It is a further object of this invention to provide a screen printing frame that is modular in construction, permitting screen frames to be assembled in a variety of dimensions.

Further objects of this invention can be discerned by perusing the detailed description, drawings, specifications and claims of this application.

### BRIEF DESCRIPTION OF THE DRAWINGS

The construction and operation of the invention can be readily appreciated from inspection of the drawings that accompany this application, combined with the detailed specification to follow.

FIG. 1 is a perspective drawing of the preferred embodiment of the invention, assembled.

FIG. 2 is a perspective drawing of the preferred embodiment of the invention, disassembled.

FIG. 3 is a top cross-section of the frame side with tongues.

FIG. 4 is side view of the frame side with tongues.

FIG. 5 is a side view of the frame side with slots

FIG. 6 is a top cross-section view of the frame side with slots

FIG. 7 is the other side view of the frame side with slots

FIG. 8 is a perspective drawing of the invention with embedded steel liner and registration holes

### DETAILED DESCRIPTION OF THE INVENTION

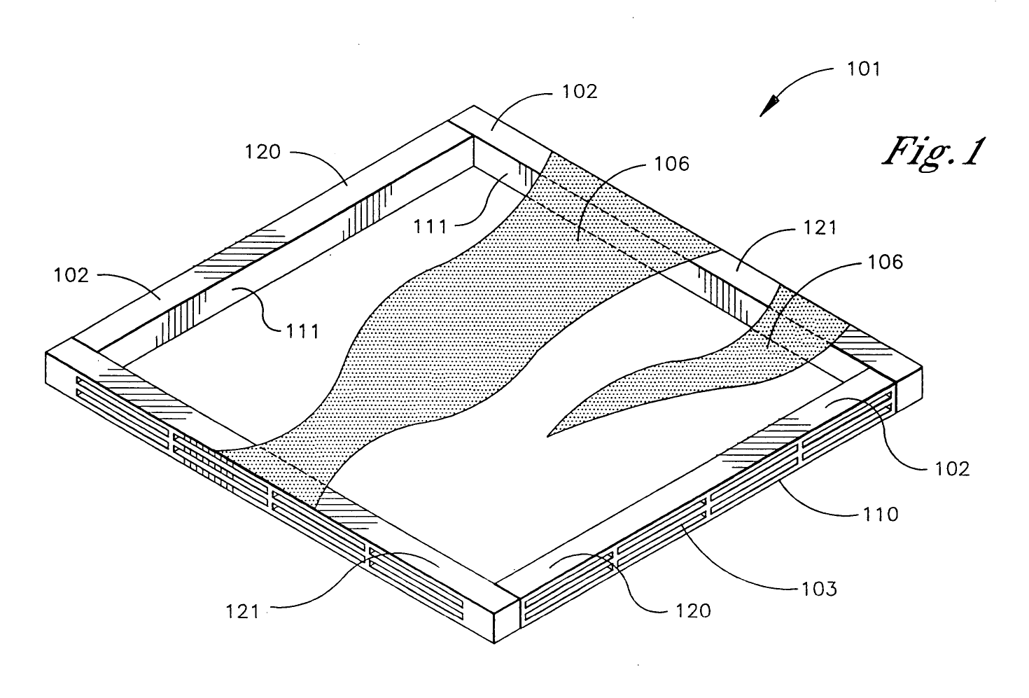

The invention is best described by referring to the preferred embodiment illustrated in the drawings. Referring to FIG. 1, a modular screen printing frame (modular frame)¹⁰¹ is a rectangular structure comprised of four pieces of injection molded or cast material. The modular frame possesses a top edge¹⁰², a bottom edge¹¹⁰, an interior edge¹¹¹, and a plurality of support ribs¹⁰³ which, in the preferred embodiment, are parallel to the top and bottom edges^{102,110} of the modular frame¹⁰¹ and perpendicular to the interior edge¹¹¹. In other embodiments, these support ribs¹⁰³ could be cast such that they form an angle to the top and bottom edges^{102,110}. In a particular alternate embodiment, the bottom edge¹¹⁰ can possess bottom support ribs while the sides and top are solid.

The silk screen fabric¹⁰⁶ is fixedly attached to the top surface of the modular frame. The silk screen fabric¹⁰⁶ can be made from a number of different materials including polyester and metal.

In FIG. 2, the modular nature of this design is shown. The two types of frame members in the preferred embodiment are illustrated, the tongue frame member¹²⁰ and the slot frame member¹²¹. The tongue frame member¹²⁰ possesses the support rib¹⁰³ features described above for a side member of the modular frame¹⁰¹ as well as two tongues¹²² extending from each end of the tongue frame member¹²⁰. Correspondingly, there are two slots¹²³ in the ends of the slot frame member¹²¹ as shown in FIG. 2. The slots¹²³ and the tongues¹²² are cast in the frame members such that they will mate together as the modular frame¹⁰¹ is assembled. The silk screen fabric¹⁰⁶ can then be attached fixedly to the assembled modular frame¹⁰¹ as shown in FIG. 1.

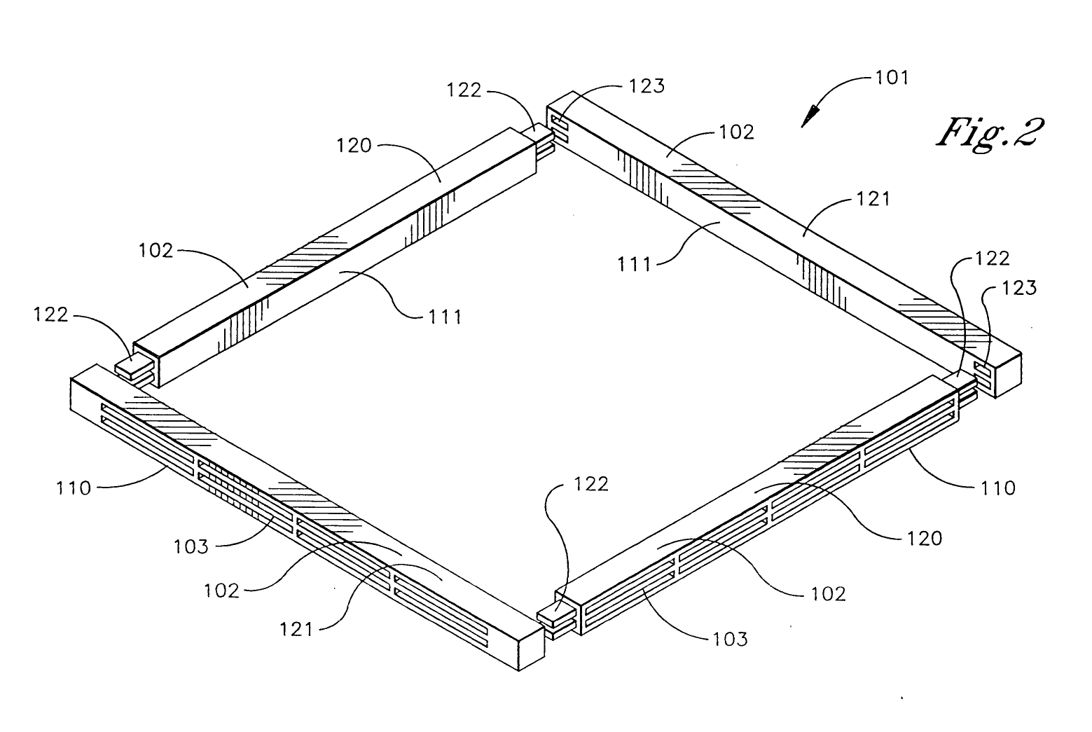

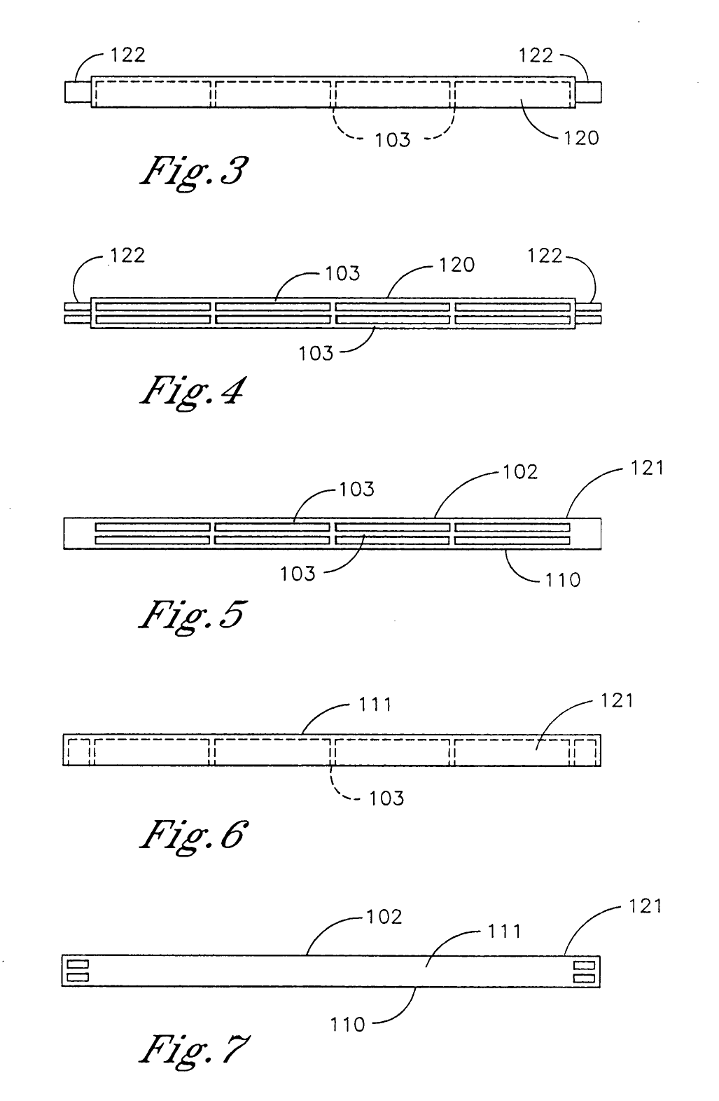

FIG. 3 and FIG. 4 show how the tongues¹²² and the support ribs¹⁰³ are arranged on the tongue frame member¹²⁰. FIG. 5, FIG. 6, and FIG. 7 show how the slots¹²³ and the support ribs¹⁰³ are arranged on the slot frame member¹²¹.

The modular frame¹⁰¹ itself can be made of several materials, including nylon, styrene, polypropylene, or metal. Metals include aluminum or steel. The preferred embodiment of this invention is a cast plastic modular frame¹⁰¹ and a polyester silk screen fabric106 with the silk screen fabric¹⁰⁶ attached to the modular frame¹⁰¹ by means of adhesive.

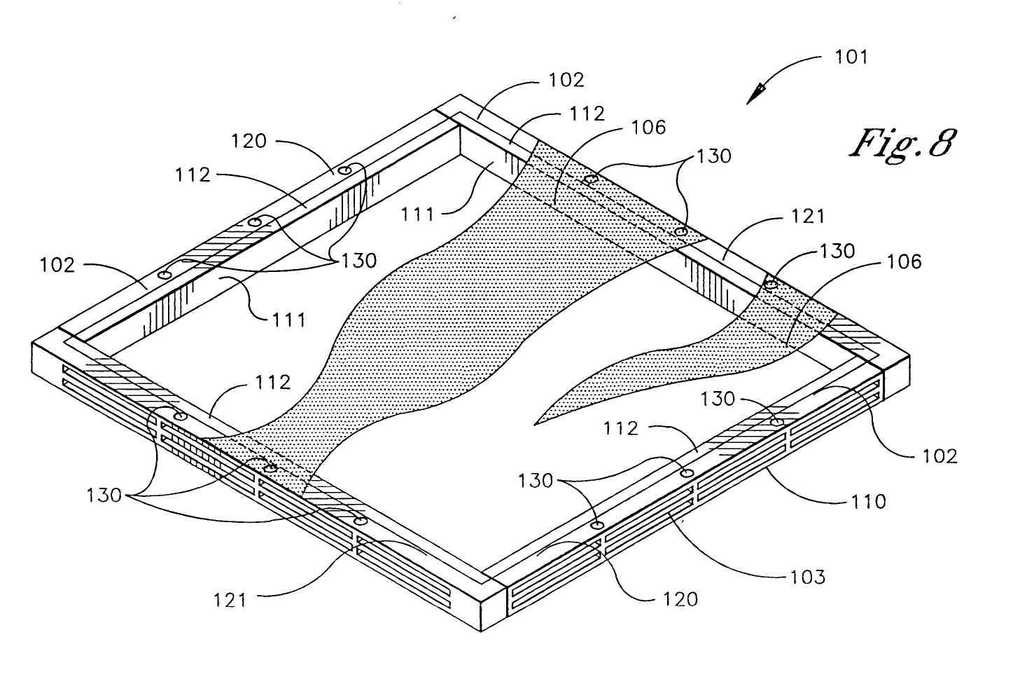

A further alternative embodiment of this invention, as shown in FIG. 8, where the plastic used for the modular frame¹⁰¹ will not hold the silk screen fabric¹⁰⁶ adequately, the silk screen fabric¹⁰⁶ being attached by means of adhesive, is to add an aluminum or steel liner¹¹² to the top edge¹⁰² of the modular frame¹⁰¹, the steel liner¹¹² fixedly attached to the top edge¹⁰² of the modular frame¹⁰¹ by means of adhesive, the silk screen fabric¹⁰⁶ then connected fixedly to the aluminum or steel liner¹¹² by means of adhesive. The alternate embodiment in FIG. 8 also possesses registration holes¹³⁰, which help hold the modular frame¹⁰¹ in place when holding pins (not shown) are inserted.

While the foregoing describes a preferred embodiment and several alternative embodiments, variation on this design and equivalent designs may be resorted to in the scope and spirit of the claimed invention.

What is claimed is:

1. 1. A screen printing frame and screen,
the screen printing frame comprised of four screen sides, each screen side possessing an interior edge, a top edge, an outside edge, a bottom edge and a plurality of support ribs,
the screen sides manufactured by means of casting or injection molding screen side material,
the screen printing frame assembled from four screen sides where two of the screen sides are of length A and two of the sides are of length B, the screen sides joined to each other by means of a connective mechanism, the screen sides joined to each other at a right angle, the screen printing frame in the shape of a rectangle where A is not equal to B, the screen printing frame in the shape of a square where A is equal to B,
the screen comprised of a fabric, the screen stretched over the top edges of the screen sides, the screen fixedly attached to the screen printing frame.

2. The screen printing frame and screen as in claim 1, where the plurality of support ribs is disposed between and parallel to the top edge and the bottom edge and perpendicular to the interior edge of each screen side, the plurality of support ribs merged solidly into the material of the interior edge and running longitudinally down the side of each screen side.

3. The screen printing frame and screen as in claim 1, where the plurality of support ribs is disposed in the bottom edge of each screen side, the interior edge, top edge and outside edge of each screen side being solid, the plurality of support ribs merging solidly into the interior and outside edge and the top edge of each screen side.

4. A screen printing frame and screen as in claim 1 where the screen is fixedly attached to the screen printing frame by means of adhesive connecting the screen to the top edge of each screen side.

5. A screen printing frame and screen as in claim 1 where the top edge of each screen side is inlaid with a metal liner, the metal liner attached fixedly to the top edge of the screen side, the upper surface of the metal liner flush with the top edge of the screen side.

6. A screen printing frame and screen as in claim 1 where the screen sides are bowed outwards slightly to confer greater strength to the screen printing frame.

7. A screen printing frame and screen as in claim 1 where the connective mechanism is a tongue and groove joint.

8. A screen printing frame and screen as in claim 1 where the screen side material is plastic.

9. A screen printing frame and screen as in claim 1 where the screen side material is metal.

10. A screen printing frame and screen as in claim 1 where the screen sides possess a plurality of registration holes.
